(19) United States
(12) Patent Application Publication
(10) Pub. No.: US 2026/0340206 A1
(43) Pub. Date: Oct. 29, 2026

(54) ELECTRONIC DEVICE FOR CHANGING SCREEN DISPLAYED ON DISPLAY AND METHOD OF OPERATING THE SAME

(71) Applicant: Samsung Electronics Co., Ltd., Suwon-si (KR)

(72) Inventors: Jaewoo SEO, Suwon-si (KR); Joonghwan LEE, Suwon-si (KR); Bumjun KWON, Suwon-si (KR); Jungil CHO, Suwon-si (KR); Moongyu JUNG, Suwon-si (KR); Youngbae JEON, Suwon-si (KR); Iljoo KIM, Suwon-si (KR)

(21) Appl. No.: 19/425,299

(22) Filed: Dec. 18, 2025

Related U.S. Application Data
(63) Continuation of application No. PCT/KR2025/022155, filed on Dec. 18, 2025.

(30) Foreign Application Priority Data
Dec. 18, 2024 (KR) 10-2024-0190033
Nov. 5, 2025 (KR) 10-2025-0165666
Dec. 16, 2025 (KR) 10-2025-0200961

(51) Int. Cl. G06F 21/84; G06F 3/04817; G09G 3/20

(52) U.S. Cl. CPC G06F 21/84; G06F 3/04817; G09G 3/2092; G09G 2320/066; G09G 2320/10; G09G 2358/00

(57) ABSTRACT

An electronic device may include a display, at least one processor, and memory storing instructions, wherein the instructions may, when executed by the at least one processor individually and/or collectively, cause the electronic device to: display a first image including first information on the display; based on performing a function for screen security, identify a first security distance at which the first information is not discernible by person's eyes when the person views the display; identify a first value for modifying the first image based on the first security distance; based on the first value, obtain a second image by converting an object representing the first information included in the first image through a first filter corresponding to a first frequency band and a third image by converting a designated image different from the first image through a second filter corresponding to a second frequency band different from the first frequency band; obtain a fourth image in which the first information is not discernible by the eyes at a distance greater than or equal to the first security distance from the display, using the second image and the third image; and modify the first image into the fourth image.

### CROSS-REFERENCE TO RELATED APPLICATIONS

This application is a continuation of International Application No. PCT/KR2025/022155 designating the United States, filed on Dec. 18, 2025, in the Korean Intellectual Property Receiving Office and claiming priority to Korean Patent Application Nos. 10-2024-0190033, filed on Dec. 18, 2024, 10-2025-0165666, filed on Nov. 5, 2025, and 10-2025-0200961, filed on Dec. 16, 2025, in the Korean Intellectual Property Office, the disclosures of each of which are incorporated by reference herein in their entireties.

### BACKGROUND

### Field

The disclosure relates to an electronic device for changing a screen displayed on a display and a method of operating the same.

### Description of Related Art

More and more services and additional functions are being provided through electronic devices, e.g., smartphones, or other portable electronic devices. To meet the needs of various users and raise use efficiency of electronic devices, communication service carriers or device manufacturers are jumping into competitions to develop electronic devices with differentiated and diversified functionalities. Accordingly, various functions that are provided through electronic devices are evolving more and more.

An electronic device may display a screen including personal information or sensitive information. For example, an electronic device may display private personal information, financial transaction information, or information subject to confidentiality obligations. In this case, in order to prevent others from viewing the personal information or sensitive information, an electronic device may modify the personal information or sensitive information included in the screen so that only a user may identify it.

The above-described information may be provided as background for the purpose of helping understanding of the disclosure. No claim or determination is made as to whether any of the foregoing is applicable as background art in relation to the disclosure.

### SUMMARY

According to an example embodiment, an electronic device may include: a display, at least one processor, comprising processing circuitry, and memory storing instructions. wherein at least one processor, individually and/or collectively, may be configured to execute the instructions and to cause the electronic device to: determine to display a first image including first information on the display; based on performing a function for screen security, identify a first security distance at which the first information is not discernible by person's eyes when the person views the display; identify a first value for modifying the first image based on the first security distance; based on the first value, obtain a second image by converting an object representing the first information included in the first image through a first filter corresponding to a first frequency band and a third image by converting a designated image different from the first image through a second filter corresponding to a second frequency band different from the first frequency band; obtain a fourth image in which the first information is not discernible by the eyes at a distance greater than or equal to the first security distance from the display, using the second image and the third image; and modify the first image into the fourth image.

According to an example embodiment, a method of operating an electronic device includes: determining to display a first image including first information on a display included in the electronic device; identifying a first security distance at which the first information is not discernible by person's eyes when the person views the display, based on performing a function for screen security; identifying a first value for modifying the first image based on the first security distance; obtaining a second image by converting an object representing the first information included in the first image through a first filter corresponding to a first frequency band and a third image by converting a designated image different from the first image through a second filter corresponding to a second frequency band different from the first frequency band, based on the first value; obtaining a fourth image in which the first information is not discernible by the eyes at a distance greater than or equal to the first security distance from the display, using the second image and the third image; and modifying the first image into the fourth image.

According to an example embodiment, in a non-transitory computer-readable storage medium storing instructions, the instructions may, when executed by at least one processor, comprising processing circuitry, of an electronic device, individually or collectively, cause an electronic device to: determine to display a first image including first information on a display included in the electronic device, identify a first security distance at which the first information is not discernible by person's eyes when the person views the display based on performing a function for screen security, identify a first value for modifying the first image based on the first security distance, obtain a second image by converting an object representing the first information included in the first image through a first filter corresponding to a first frequency band and a third image by converting a designated image different from the first image through a second filter corresponding to a second frequency band different from the first frequency band based on the first value, obtain a fourth image in which the first information is not discernible by the eyes at a distance greater than or equal to the first security distance from the display using the second image and the third image, and modify the first image into the fourth image.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an electronic device in a network environment according to an embodiment.

FIG. 2 is a block diagram illustrating an example configuration of an electronic device according to various embodiments.

FIG. 3 is a diagram illustrating an example method in which an electronic device modifies information included in a screen so that only a user may identify it, according to various embodiments.

FIGS. 4A and 4B are diagrams illustrating a second image and a third image for modifying information included in a screen, according to various embodiments.

FIG. 5A is a diagram illustrating an example method in which an electronic device identifies a similarity between the second image and the fourth image and a similarity between the third image and the fourth image, according to various embodiments.

FIG. 5B includes graphs illustrating an example method of determining CSF according to the age and the color of a background image, according to various embodiments.

FIG. 6 is a graph illustrating an example method in which an electronic device identifies a value representing a ratio between the first similarity and the second similarity based on a value corresponding to a designated distance, according to various embodiments.

FIG. 7 is diagram illustrating an electronic device displaying a screen including a fourth image, according to various embodiments.

FIG. 8 is a flowchart illustrating an example method in which an electronic device modifies a first image including first information into a fourth image that others may not identify, according to various embodiments.

FIG. 9 is a diagram illustrating an example method in which an electronic device modifies a first image including first information into a fourth image that others may not identify, according to various embodiments.

FIG. 10 is a includes graphs illustrating an example method in which an electronic device obtains a second image in which an object included in a first image is transformed, according to various embodiments.

FIG. 11 is a flowchart illustrating an example method in which an electronic device obtains a fourth image considering an error in security distance, according to various embodiments.

FIG. 12 is a graph illustrating an example method in which an electronic device obtains a fourth image considering an error in security distance, according to various embodiments.

FIG. 13 is a diagram illustrating an example user interface supported by an application for screen security, according to various embodiments.

### DETAILED DESCRIPTION

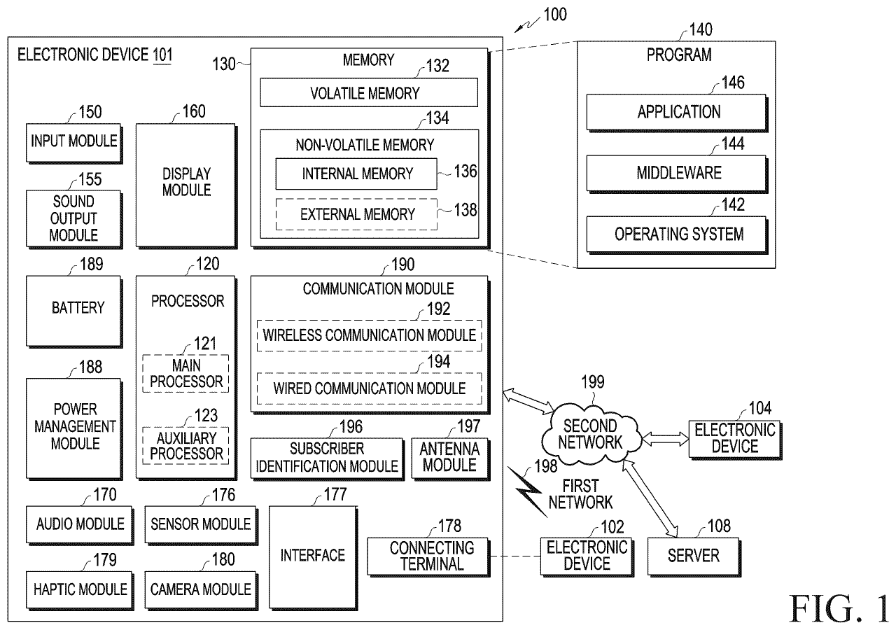

FIG. 1 is a block diagram illustrating an electronic device 101 in a network environment 100, according to various embodiments. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

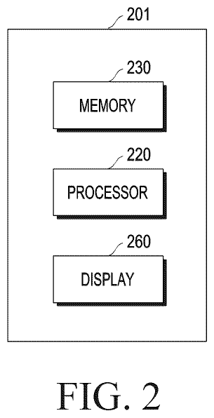

FIG. 2 is a block diagram illustrating an example configuration of an electronic device according to various embodiments.

Referring to FIG. 2, according to an embodiment, an electronic device 201 may include a processor (e.g., including processing circuitry) 220 (e.g., the processor 120 of FIG. 1), memory 230 (e.g., the memory 130 of FIG. 1), and a display 260 (e.g., the display module 160 of FIG. 1).

According to an embodiment, the processor 220 may control the overall operation of the electronic device 201. For example, the processor 220 may be implemented to be identical or similar to the processor 120 of FIG. 1. According to an embodiment, the processor 220 may execute software (e.g., the program 140 of FIG. 1) to control at least one other component (e.g., a hardware or software component) of the electronic device 201 connected with the processor 220 and may perform data processing or computation based on instructions. An instruction according to an embodiment may include a command composed of machine language that may be processed by the electronic device 201 or the processor 220. For example, the instruction may include a command corresponding to an operation instruction used in the program.

Meanwhile, FIG. 2 illustrates that the electronic device 201 includes one processor 220, but this is exemplary and the technical spirit of the disclosure may not be limited thereto. For example, the electronic device 201 may include at least one processor. For example, the processor 220 may be implemented as at least one processor. The description of the processor 120 above applies equally to the processor 220, and as such the description may not be repeated here.

According to an embodiment, the memory 230 (e.g., the memory 130 of FIG. 1) may store at least one instruction (or instruction) that causes at least one operation of the electronic device 201. At least one instruction, when executed by the processor 220, may cause the electronic device 201 to perform the corresponding operation.

According to an embodiment, the processor 220 may display a screen on the display 260. For example, the screen may include an application execution screen, a home screen, a lock screen, or a pop-up window.

According to an embodiment, when a user inputs execution of a screen security function for a screen displayed on the display 260, the processor 220 may execute a program (e.g., the program 140 of FIG. 1) corresponding to an application (or function) related to screen security stored in the memory 230. According to another embodiment, when a screen security function for a screen displayed on the display 260 is automatically executed, the processor 220 may execute a program (e.g., the program 140 of FIG. 1) corresponding to an application (or function) related to screen security stored in the memory 230. For example, when a specific screen (e.g., a pin code input screen, a password input screen, a personal message display screen, and/or an execution screen of a designated application) is displayed on the display 260, the screen security function may be automatically executed. For example, the designated application may include a financial transaction application, a messenger application, and/or a social network service (SNS) application.

According to an embodiment, the processor 220 may replace a first screen image including first information included in a screen displayed on the display 260 with a second screen image according to execution of the application (or function) related to screen security. For example, the first screen image may represent an image related to the first information included in the screen. For example, the first information may include private information, personal information, financial transaction information, or information subject to confidentiality obligations. For example, the second screen image may represent an image in which at least a portion of the first screen image is transformed so that only a user may identify the first information. For example, the first information included in the second screen image may be visually discernible within a designated distance from the display 260. For example, the first information included in the second screen image may not be discernible through (or by) the person's eyes at a distance greater than or equal to the designated distance from the display 260. For example, the first information included in the second screen image may be discernible through the person's eyes at a distance less than the designated distance from the display 260. For example, the person means a person in general, and may include a user and/or other people.

According to an embodiment, the first screen image may include a first image including the first information. For example, the first image may include various types of objects including text, letters, numbers, a pin code, or content. For example, the object may represent the first information. The first image may include a background (or background image) corresponding to the remaining portion except for the object.

According to an embodiment, the second screen image may include an image in which a first object representing the first information included in the first image and the background are transformed. For example, the second screen image may include a fourth image generated using a second image (e.g., a high-frequency image) obtained by converting the first object representing the first information included in the first image through a first filter corresponding to a first frequency band and a third image obtained by converting a designated image different from the first image through a second filter (e.g., a low-pass filter) corresponding to a second frequency band different from the first frequency band.

According to an embodiment, the second image may include a second object in which the shape and/or color of the first object included in the first image is transformed based on a value corresponding to the first security distance. For example, the second object included in the second image may represent the first information. However, the second object may differ from the first object in at least some of the shape, size, and/or color. For example, the third image may include an image in which a designated image different from the first image (e.g., an image not related to the first image) is transformed (e.g., blurred) based on a value corresponding to the first security distance.

According to an embodiment, the fourth image may be generated or obtained using the second image and the third image. For example, the fourth image may include an image in which at least a portion of the second image and at least a portion of the third image are overlapped. For example, in the fourth image, a second object representing the first information may be overlapped on the third image. For example, in the fourth image, the first information may not be easily discernible through the eyes of the person (e, g. a user and/or other people) at a distance greater than or equal to the first security distance from the display 260. For example, the person means a person in general, and may include a user and/or other people.

According to an embodiment, the processor 220 may identify a similarity between the second image and the third image. The processor 220 may identify the similarity based on whether a first attribute including at least one of a size, color, or type of an object included in the second image matches a second attribute including at least one of a color, type, or pattern of the third image. The processor 220 may identify a second security distance that is longer or shorter than the first security distance by a distance (e.g., distance error) corresponding to the similarity. For example, the second security distance may represent a security distance in which the degree to which the first information is not easily discernible through the user's eyes is corrected according to the similarity between the second image and the third image. The processor 220 may generate (or obtain) an image in which the first information is not discernible through the user's eyes at a distance greater than or equal to the second security distance from the display 260. The processor 220 may obtain the generated image as the fourth image.

In the disclosure, not being able to identify the first information may include not only completely failing to identify the first information but also not being able to easily identify the first information. For example, the first information included in the second screen image may not be easily discernible through the eyes of the person (e, g. a user and/or other people) at a distance greater than or equal to the designated distance from the display 260.

In the disclosure, replacing or changing the first screen image with the second screen image may include replacing or changing the first image with the fourth image.

According to an embodiment, the processor 220 may generate or obtain a second screen image processed not to be visually discernible at a distance greater than or equal to the designated distance from the display 260, based on the first screen image and the designated distance. For example, the processor 220 may generate a second screen image processed so that the first information is not discernible through the person's eyes at a distance greater than or equal to the security distance from the display 260 when the person (e, g. a user and/or other people) views the display 260, based on identifying a security distance designated by a user input. For example, the first security distance may be designated or selected by a user input to a user interface (e.g., an execution screen of the application) supported by an application for screen security. Further, the first security distance may be adjusted by a user input to the user interface. For example, the processor 220 may identify the first security distance based on user input to a user interface (e.g., execution screen) supported by the application.

According to an embodiment, the processor 220 may obtain or identify information about the user's age, the user's gender, the user's eyesight, and/or the user's ocular health information through the user interface. Further, information about an object color and/or background color to be included in the second screen image or the fourth image may be obtained or identified. The processor 220 may obtain the second screen image (or the fourth image) based on information obtained or identified through the user interface.

According to an embodiment, the processor 220 may replace or change the first screen image displayed on the display 260 with the second screen image. In other words, the processor 220 may change the first screen image including the first information to a second screen image processed so that the first information may not be easily identified at the security distance.

Through the above-described method, the processor 220 may prevent/block/obscure others located at a distance designated from the display 260 from identifying the first information while the user is identifying the first information. For example, the processor 220 may prevent/block/obscure others from identifying the user's personal or sensitive information over the user's shoulder.

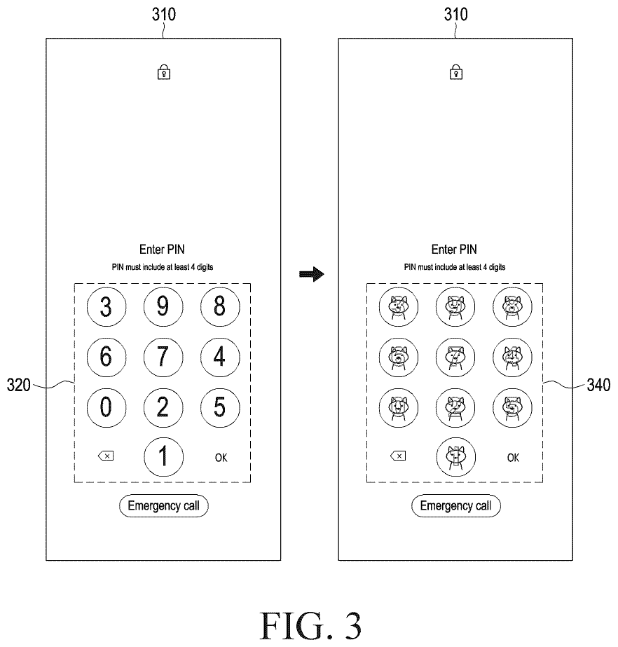

FIG. 3 is a diagram illustrating an example method in which an electronic device modifies information included in a screen so that only a user may identify it, according to various embodiments.

Referring to FIG. 3, according to an embodiment, an electronic device (e.g., the electronic device 201 of FIG. 2) may display a screen 310 on a display (e.g., the display 260 of FIG. 2). For example, the screen 310 may include a first screen image 320. The first screen image 320 may represent an input window for entering a pin code (or password), and the input window may include a plurality of number images. For example, one number image among the number images may include an object representing the corresponding number and a background excluding the object.

According to an embodiment, when a screen security function is executed, the electronic device 201 may replace or change the first screen image 320 with a second screen image 340. For example, the electronic device 201 may change a first image (e.g., a number key image) included in the first screen image 320 to a fourth image (e.g., an image in which a number key image is overlapped on a cat image) that others may not easily identify. For example, the fourth image may be identified as a background image (e.g., a cat image) through the eyes of the person (e, g. a user and/or other people) at a distance greater than or equal to the designated distance from the display 260. Further, the fourth image may not be discernible as a number (or number object) through the person's eyes at a distance greater than or equal to the designated distance. On the other hand, the fourth image may be discernible as a number (or number object) through the person's eyes at a distance less than the designated distance from the display 260. Further, the fourth image may not be discernible as a background image (e.g., a cat image) at a distance less than the designated distance.

According to an embodiment, the electronic device 201 may obtain a fourth image with an adjusted discernible distance or recognizable distance by adjusting a first modulation value (or modulation ratio) of a first filter for obtaining a second image (e.g., a sigma value of the first filter) and/or a second modulation value (or modulation ratio) of a second filter for obtaining a third image (e.g., a sigma value of the second filter).

For example, when user input adjusting the security distance is identified, the electronic device 201 may identify a first value based on the corresponding security distance. For example, the first value may be a value for identifying modulation values according to the security distance. The electronic device 201 may determine the first modulation value of the first filter and the second modulation value of the second filter according to the first value. The electronic device 201 may generate or obtain a fourth image using the second image based on the first modulation value and the third image based on the second modulation value. Further, the electronic device 201 may generate or obtain the second screen image 340 including the fourth image. Accordingly, the electronic device 201 may generate or obtain the second screen image 340 according to various recognizable distances or discernible distances. Further, the electronic device 201 may replace or change the first screen image 320 with the second screen image 340 that others may not recognize or identify at a security distance designated by a user.

Through the above-described method, the processor 220 may prevent/block/obscure others located at a distance designated as the security distance from the display 260 from identifying the first information while the user is identifying the first information (e.g., an input window for entering a pin code or password).

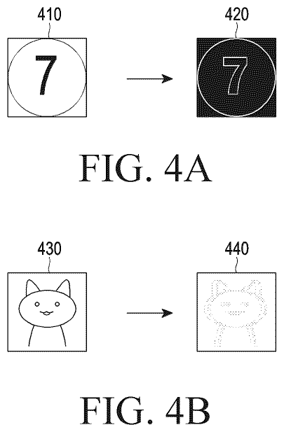

FIGS. 4A and 4B are diagrams illustrating a second image and a third image for modifying information included in a screen, according to various embodiments.

Referring to FIGS. 4A and 4B, according to an embodiment, an electronic device (e.g., the electronic device 201 of FIG. 2) may display a screen including a first screen image related to first information on a display (e.g., the display 260 of FIG. 2). The electronic device 201 may obtain a second image 420 and a third image 440 in obtaining or generating a second screen image to replace or change the first screen image.

According to an embodiment, the second image 420 may represent an image in which the shape and/or form of an object 410 representing the first information included in the first image is transformed. For example, the object 410 may represent a picture, text, number, or symbol related to the first information. The electronic device 201 may obtain or generate the second image 420 in which the object 410 is transformed through a first filter (e.g., a high pass filter) corresponding to a first frequency band. For example, the electronic device 201 may obtain or generate the second image 420 in which the thickness of at least one of an inner part and an outer part of the object 410 is adjusted with respect to a boundary between the object 410 and a background excluding the object 410 through the first filter.

According to an embodiment, the third image 440 may represent an image in which a background image 430 representing a shape and/or form different from (or unrelated to) the object 410 representing the first information is transformed. For example, the background image 430 may represent a picture, text, number, or symbol unrelated to the first information. For example, the background image 430 may be an image stored in the electronic device 201. The background image 430 may be determined or selected based on the type, form, shape, and/or color of the object 410 among images stored in the electronic device 201. The electronic device 201 may obtain or generate the third image 440 in which the background image 430 is transformed (e.g., a blur effect is applied) through a second filter (e.g., a low pass filter) corresponding to a second frequency band (e.g., a frequency band lower than the first frequency band). For example, the electronic device 201 may obtain or generate the third image 440 in which the background image 430 is blurred through the second filter.

According to an embodiment, the electronic device 201 may obtain or generate a fourth image using (or by combining) the second image 420 and the third image 440. For example, the fourth image may represent an image in which an object of the second image 420 (e.g., an object representing the number 7) is overlapped on the third image 440 (e.g., a blurred cat picture background). For example, the fourth image may be recognized or identified as the object at a distance less than a predetermined distance from the display 260. Further, the fourth image may be recognized or identified as a shape corresponding to the third image 440 (e.g., a cat image) at a distance greater than or equal to the predetermined distance from the display 260.

According to an embodiment, the electronic device 201 may obtain or generate a second screen image in which the first information may not be identified through the eyes of the person (e, g. a user and/or other people) at a distance greater than or equal to the designated distance from the display 260 using the second image 420, the third image 440, and the fourth image. For example, the electronic device 201 may adjust a discernible distance (or recognizable distance) at which the fourth image may be identified (or recognized) as the object through the eyes by adjusting a modulation ratio (e.g., the first modulation value and the second modulation value) of the first filter and the second filter for generating the fourth image.

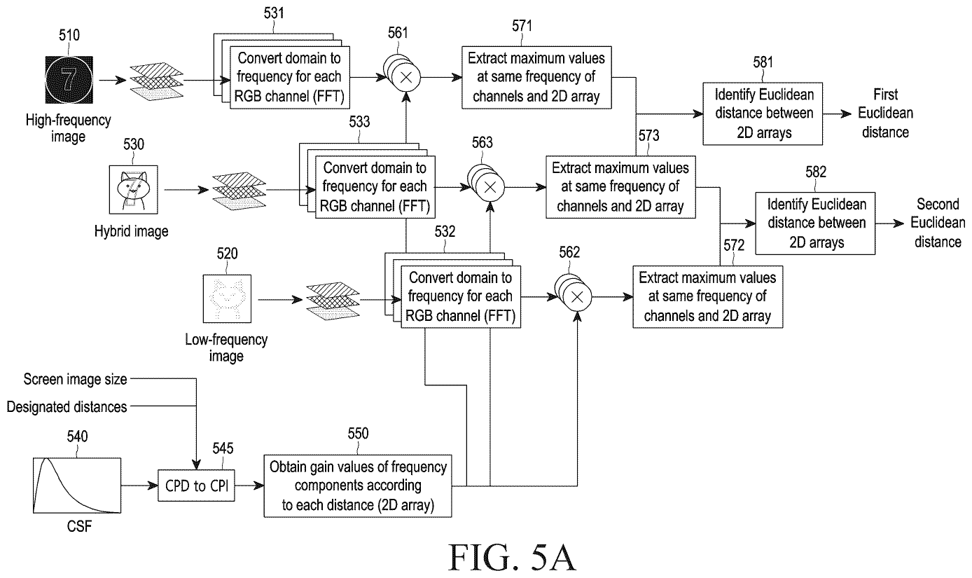

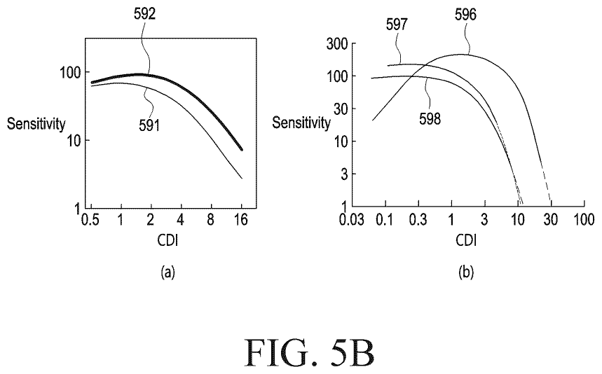

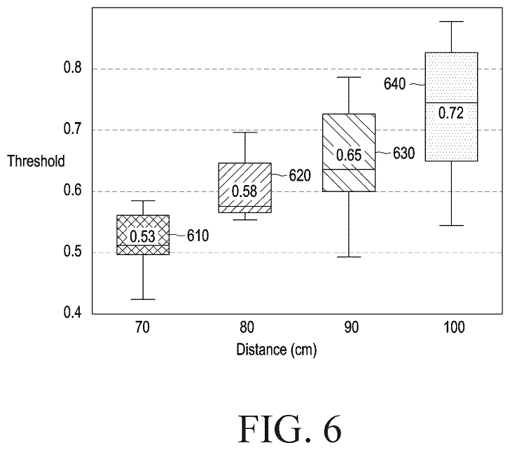

According to an embodiment, the electronic device 201 may identify a designated first value corresponding to the corresponding security distance based on a designated security distance. The electronic device 201 may identify filter values of the first filter and the second filter based on the identified first value. For example, the first value may be determined based on a first similarity between the second image and the fourth image and a second similarity between the third image and the fourth image using a contrast sensitivity function (CSF) representing distance-dependent identification sensitivity. In this regard, FIGS. 5 and 6 below will specifically describe how the first value is determined based on the first similarity and the second similarity.

FIG. 5A is a diagram illustrating an example method in which an electronic device identifies a similarity between the second image and the fourth image and a similarity between the third image and the fourth image, according to various embodiments.

Referring to FIG. 5A, according to an embodiment, a second image 510 (e.g., a high-frequency image) may include an object in which an object representing the first information included in the first image is at least partially transformed. For example, the second image 510 may be obtained or generated identically or similarly to the second image 420 described with reference to FIG. 4.

According to an embodiment, a third image 520 (e.g., a low-frequency image) may include an image in which an image unrelated to the first information included in the first image (e.g., a cat image) is at least partially transformed. For example, the third image 520 may be obtained or generated identically or similarly to the third image 440 described with reference to FIG. 4.

According to an embodiment, a fourth image 530 (e.g., a hybrid image) may be obtained or generated using (e.g., by synthesizing or combining) the second image 510 and the third image 520. For example, the fourth image 530 may be obtained or generated identically or similarly to the fourth image described with reference to FIG. 4.

According to an embodiment, each of the second image 510, the third image 520, and the fourth image 530 may be separated into a plurality of channels corresponding to red (R), green (G), and blue (B) (hereinafter, RGB) (e.g., channels corresponding to a plurality of colors).

According to an embodiment, in steps 531, 532, and 533, the domain of each of the second image 510, the third image 520, and the fourth image 530 may be converted to spatial frequency units for each RGB channel. Thereafter, the domain of each of the second image 510, the third image 520, and the fourth image 530 for each RGB channel may be converted to the spatial frequency unit by Fourier transform (e.g., fast Fourier transform (FFT)).

According to an embodiment, a first similarity between the second image 510 and the fourth image 530 and a second similarity between the third image 520 and the fourth image 530 may be obtained using a contrast sensitivity function (CSF) representing distance-dependent identification sensitivity. For example, the first similarity may be determined based on a first Euclidean distance between the distance-specific spatial frequency of the second image 510 identified using the CSF and the distance-specific spatial frequency of the fourth image 530. For example, the second similarity may be determined based on a second Euclidean distance between the distance-specific spatial frequency of the third image 520 identified using the CSF and the distance-specific spatial frequency of the fourth image 530. In this case, in step 550, a gain value of a frequency component according to each distance may be obtained based on CSF 540. In obtaining the gain value, the domain of CSF 540 may be changed to spatial frequency units. For this purpose, in step 545, perceptual frequency units may be changed to spatial frequency units. For example, CPD (cycle per degree) representing perceptual frequency units (e.g., the number of times pixels of the same pattern repeat within 1 degree) may be changed to CPI (cycle per image) representing spatial frequency units (e.g., the number of times pixels of the same pattern repeat within one image). In this case, the electronic device 201 may change the perceptual frequency units of CSF 540 to spatial frequency units considering information about the size of the screen displayed on the display 260 and distances designated in CSF 540. Thereafter, the electronic device 201 may obtain gain values of frequency components according to each distance, and for example, the gain values may be configured as a two-dimensional array.

According to an embodiment, in steps 561, 562, 563, values obtained by multiplying the gain values for each distance by the spatial frequency for each channel for the second image 510, the third image 520, and the fourth image 530 may be obtained.

According to an embodiment, in steps 571, 572, 573, maximum values among the multiplied values of a plurality of channels at the same frequency may be extracted as values of the corresponding frequency. For example, the extracted values may be the most dominant values among the plurality of channels at the same frequency, and the extracted values may be configured as a two-dimensional array according to spatial frequency. For example, first maximum values configured as a two-dimensional array for the second image 510, second maximum values configured as a two-dimensional array for the third image 520, and third maximum values configured as a two-dimensional array for the fourth image 530 may be obtained.

According to an embodiment, the electronic device 201 may identify a first Euclidean distance between the first maximum values and the third maximum values in step 581. For example, the identified first Euclidean distance may represent the first similarity between the second image 510 and the fourth image 530. For example, as the first Euclidean distance increases, high-frequency components of the fourth image 530 that a person may perceive at a designated distance may decrease, and the similarity between the fourth image 530 and the second image 510 may decrease.

According to an embodiment, the electronic device 201 may identify a second Euclidean distance between the second maximum values and the third maximum values in step 582. For example, the identified second Euclidean distance may represent the second similarity between the third image 520 and the fourth image 530. For example, as the second Euclidean distance increases, high-frequency components of the fourth image 530 that a person may perceive at a designated distance may decrease, and the similarity between the fourth image 530 and the third image 520 may increase.

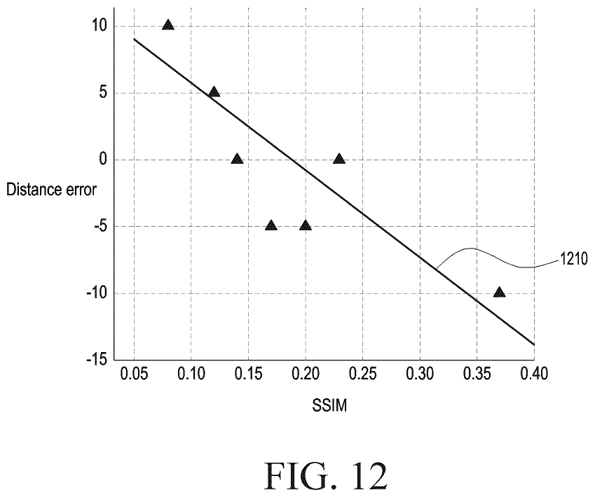

According to an embodiment, the first value may be a value representing a ratio between the first Euclidean distance and the second Euclidean distance. For example, the first value may represent a Euclidean distance ratio (EDR). The electronic device 201 may estimate or identify the first security distance, which is the maximum distance at which a person may perceive information, based on the first value. For example, the electronic device 201 may primarily perform the process described with reference to FIG. 6 to estimate or identify the first security distance, and may additionally perform the process described with reference to FIG. 12 secondarily.

According to an embodiment, the graph of FIG. 6 may exemplarily present the first value, the Euclidean distance ratio, according to the first security distance. For example, the graph of FIG. 6 may indicate that the first value increases as the first security distance increases. The electronic device 201 may primarily estimate or identify the first security distance from the first value derived or obtained according to FIG. 5. For example, according to the graph of FIG. 6, when the first value has a value around 0.65, the electronic device 201 may primarily estimate or identify the first security distance as 90 cm.

According to an embodiment, the graph of FIG. 12 may represent an index for adjusting the first security distance primarily estimated according to the process described with reference to FIG. 6. For example, in FIG. 12, the x-axis may represent image similarity between original information (e.g., PIN number) and fake information (e.g., cat picture), and the y-axis may represent adjustment required distance according to similarity between images (e.g., images of original information and images of fake information). For example, the graph of FIG. 12 may indicate that the higher the similarity between two images, the shorter the first security distance tends to be. For example, when the similarity between original information and fake information is 0.35, the electronic device 201 may secondarily correct the security distance by reducing the primarily estimated first security distance by 10 cm, and may estimate or identify the final first security distance as 80 cm.

Meanwhile, the processes for FIGS. 6 and 12 is described in more detail below.

According to an embodiment, the electronic device 201 may modulate the first modulation value of the second image 510 and the second modulation value of the third image 520 until the first security distance is obtained. For example, the electronic device 201 may identify the first modulation value of the second image 510 and the second modulation value of the third image 520 that may output the intended or required first security distance by applying various known algorithms (e.g., Grid search, Gradient Descent).

Based on the above-described method, the electronic device 201 may generate or obtain the fourth image with an adjusted discernible distance (or recognizable distance) by adjusting the modulation values of the first filter and the second filter according to the first security distance. For example, the discernible distance (or recognizable distance) may represent a distance from the display 260 where the first information included in the fourth image 530 may be easily identified through the eyes of the person (e, g. a user and/or other people).

FIG. 5B includes graphs illustrating an example method of determining CSF according to the age and the color of a background image, according to various embodiments.

Referring to FIG. 5B, according to an embodiment, a first similarity between the second image (e.g., the second image 510 of FIG. 5A) and the fourth image (e.g., the fourth image 530 of FIG. 5A) and a second similarity between the third image (e.g., the third image 520 of FIG. 5A) and the fourth image 530 may be obtained using a contrast sensitivity function (CSF) representing distance-dependent identification sensitivity.

According to an embodiment, the contrast sensitivity function (CSF) may be determined based on at least one of the age, the eyesight, or the color of the first image. For example, the sensitivity of the contrast sensitivity function may be changed based on at least one of the age, the eyesight, or the color of the first image.

According to an embodiment, a first graph 591 may represent a contrast sensitivity function (e.g., a function changed to a log scale) for a first user. A second graph 592 may represent a contrast sensitivity function (e.g., a function changed to a log scale) for a second user who is older than the first user. For example, the horizontal axis of each of the first graph 591 and the second graph may represent CPD (cycle per degree), and the vertical axis may represent sensitivity.

According to an embodiment, a third graph 596 may represent a contrast sensitivity function (e.g., a function changed to a log scale) when the color of the first image (e.g., background color) is white (or black). A fourth graph 597 may represent a contrast sensitivity function (e.g., a function changed to a log scale) when the color of the first image (e.g., background color) is red/green. A fifth graph 598 may represent a contrast sensitivity function (e.g., a function changed to a log scale) when the color of the first image (e.g., background color) is blue/yellow.

According to an embodiment, the electronic device 201 may obtain or identify information about the user's age, the user's gender, the user's eyesight, and/or the user's ocular health information through a user interface of an application for screen protection. For example, the electronic device 201 may determine a contrast sensitivity function corresponding to the age considering the user's age. The electronic device 201 may obtain the first modulation value and the second modulation value that satisfy the first value corresponding to the first security distance using the determined contrast sensitivity function.

According to an embodiment, the electronic device 201 may obtain or identify information about the color of the first image (e.g., background color). For example, the electronic device 201 may determine a contrast sensitivity function corresponding to the color considering the color of the first image. The electronic device 201 may obtain the first modulation value and the second modulation value that satisfy the first value corresponding to the first security distance using the determined contrast sensitivity function.

FIG. 6 is a graph illustrating an example method in which an electronic device identifies a value representing a ratio between the first similarity and the second similarity based on a value corresponding to a designated distance, according to various embodiments.

Referring to FIG. 6, according to an embodiment, when a function for screen protection is executed, the electronic device (e.g., the electronic device 201 of FIG. 2) may identify a first security distance designated by a user input or automatically designated. The electronic device 201 may identify a first value for modifying the first image displayed on the display 260 so that others may not easily identify it based on the first security distance. For example, the first value may be determined based on the first security distance. For example, the first value may correspond to a value obtained by dividing the first similarity (e.g., the first Euclidean distance) between the second image and the fourth image from the second similarity (e.g., the second Euclidean distance) between the third image and the fourth image.

According to an embodiment, the first value may be determined based on a distribution of values (e.g., thresholds) obtained by dividing the first similarity from the second similarity according to each observation distance. For example, a first graph 610 may represent values (e.g., thresholds) obtained by dividing the first similarity from the second similarity based on a user with specific eyesight when the observation distance is 70 cm. For example, when the observation distance is 70 cm, the average value of the divided values may be 0.53. A second graph 620 may represent values (e.g., thresholds) obtained by dividing the first similarity from the second similarity based on a user with specific eyesight when the observation distance is 80 cm. For example, when the observation distance is 80 cm, the average value of the divided values may be 0.58. A third graph 630 may represent values (e.g., thresholds) obtained by dividing the first similarity from the second similarity based on a user with specific eyesight when the observation distance is 90 cm. For example, when the observation distance is 90 cm, the average value of the divided values may be 0.65. A fourth graph 640 may represent values (e.g., thresholds) obtained by dividing the first similarity from the second similarity based on a user with specific eyesight when the observation distance is 100 cm. For example, when the observation distance is 100 cm, the average value of the divided values may be 0.72. For example, when the first security distance is designated as 70 cm, the first value may be determined as 0.53 corresponding to 70 cm. Further, when the first security distance is designated as 90 cm, the first value may be determined as 0.65 corresponding to 90 cm.

According to an embodiment, when the first security distance is designated as a specific distance (e.g., 70 cm), the electronic device 201 may identify a first value (e.g., 0.53) corresponding to the specific distance and determine the first modulation value of the first filter and the second modulation value of the second filter that satisfy the first value. Thereafter, the electronic device 201 may obtain a fourth image using the second image obtained through the first filter applying the first modulation value and the third image obtained through the second filter applying the second modulation value. In other words, when the first security distance is designated as a specific distance (e.g., 70 cm), the electronic device 201 may obtain or generate a fourth image that satisfies a first value (e.g., 0.53) corresponding to the specific distance. For example, the first information included in the fourth image satisfying the first value may not be easily identified by others at a distance greater than or equal to the specific distance from the display (e.g., the display 260 of FIG. 2).

Based on the above-described method, the electronic device 201 may obtain a fourth image that satisfies the first security distance designated by a user input or automatically. Further, the electronic device 201 may change or replace the first image including the first information with the fourth image.

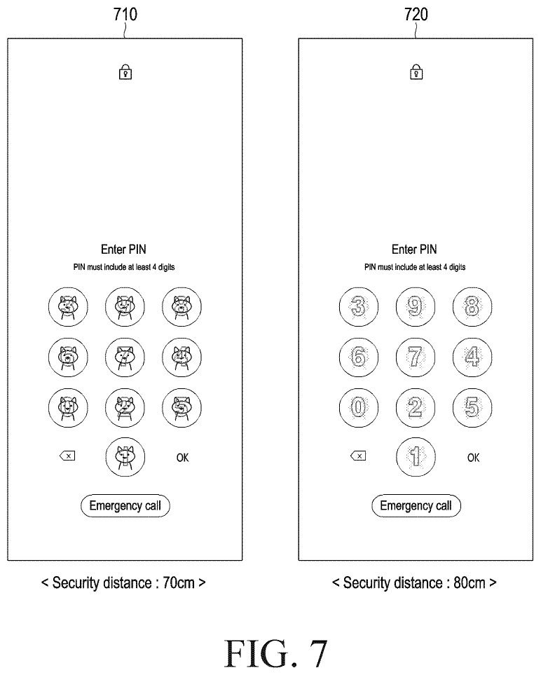

FIG. 7 is diagram illustrating an electronic device displaying a screen including a fourth image, according to various embodiments.

Referring to FIG. 7, according to an embodiment, when a security distance designated by a user input or automatically is designated as a first specific distance (e.g., 70 cm), the electronic device (e.g., the electronic device 201 of FIG. 2) may obtain or generate a fourth image that satisfies a first value (e.g., 0.53) corresponding to the first specific distance. For example, the first information (e.g., number) included in the fourth image based on the first value corresponding to the first specific distance may not be easily identified by others at a distance greater than or equal to the first specific distance from the display (e.g., the display 260 of FIG. 2). For example, the fourth image may be identified as the background image (e.g., cat image) by others at a distance greater than or equal to the first specific distance. Based on the above-described method, the electronic device 201 may display a screen image 710 (e.g., a pin code input screen) including the fourth image (e.g., an image including a number object and a cat image) as a screen protection function.

According to an embodiment, when the first security distance is designated as a second specific distance (e.g., 80 cm), the electronic device 201 may obtain or generate a fourth image that satisfies a first value (e.g., 0.58) corresponding to the second specific distance. For example, the modulation ratio of the fourth image corresponding to the second specific distance may be different from the modulation ratio of the fourth image corresponding to the first specific distance. For example, the first information (e.g., number) included in the fourth image based on the first value corresponding to the second specific distance may not be easily identified by others at a distance greater than or equal to the second specific distance from the display (e.g., the display 260 of FIG. 2). For example, the fourth image may be identified as a background image (e.g., cat image) by others at a distance greater than or equal to the second specific distance. Based on the above-described method, the electronic device 201 may display a screen image 720 (e.g., a pin code input screen) including the fourth image (e.g., an image including a number object and a cat image) as a screen protection function.

According to an embodiment, the electronic device 201 may change the first image including the first information to the fourth image for screen protection. The electronic device 201 may display the fourth image corresponding to a security distance intended by the user. Accordingly, the electronic device 201 may provide a screen protection function that prevents/blocks/obscures others from easily identifying the first information.

Meanwhile, the screens illustrated in FIG. 7 are exemplary, and the technical features of the disclosure may not be limited thereto. For example, the fourth image may be implemented in various forms (e.g., a form in which various objects and various contents are combined).

At least some of the operations of the electronic device 201 described below may be performed by the processor 220. However, for convenience of description, the following operations are described as being performed by the electronic device 201.

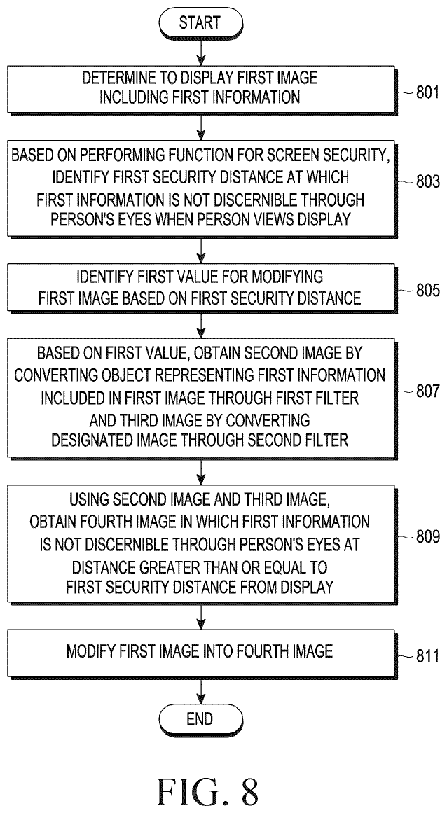

FIG. 8 is a flowchart illustrating an example method in which an electronic device modifies a first image including first information into a fourth image that others may not identify, according to various embodiments.

Referring to FIG. 8, according to an embodiment, in operation 801, an electronic device (e.g., the electronic device 201 of FIG. 2) may determine to display a first image including first information through a display (e.g., the display 260 of FIG. 2). For example, the electronic device (201) may display the first image on the display (260) based on the determination. Alternatively, the electronic device (201) may wait for displaying the first image based on the determination

According to an embodiment, in operation 803, the electronic device 201 may identify a first security distance at which the first information is not discernible through the person's eyes when the person (e, g. a user and/or other people) views a display (e.g., the display 260 of FIG. 2) included in the electronic device 201, based on performing a function for screen security. For example, the first security distance may be designated by a user input or automatically designated.

According to an embodiment, in operation 805, the electronic device 201 may identify a first value for modifying the first image based on the first security distance.

According to an embodiment, in operation 807, the electronic device 201 may obtain a second image (e.g., an image in which the shape and/or color of an object representing the first information is transformed) obtained by converting an object representing the first information included in the first image through a first filter based on the first value and a third image (e.g., a blurred image) obtained by converting a designated image (e.g., an image different from the first image) through a second filter. For example, the first modulation value of the first filter and the second modulation value of the second filter may be determined based on the first value. Further, the modulation ratio of the first filter and the second filter may also be determined based on the first value.

According to an embodiment, in operation 809, the electronic device 201 may obtain or generate a fourth image in which the first information is not easily discernible through the eyes of the person (e, g. a user and/or other people) at a distance greater than or equal to the first security distance from the display 260, using the second image and the third image. For example, the fourth image may include the first information processed so that it may not be easily identified by others. For example, the electronic device 201 may obtain or generate the fourth image by combining the second image and the third image. For example, the fourth image may include an image in which an object representing the first information included in the second image and the second image are overlapped.

According to an embodiment, in operation 811, the electronic device 201 may change (or replace) the first image with the fourth image. For example, the electronic device (201) may display a fourth image on the display (260) instead of the first image determined to be displayed on the display (260). When the first image is displayed on the display (260), the electronic device (201) may change the first image to the fourth image. Alternatively, when the first image is not displayed on the display (260) (e.g., in a display-waiting state), the electronic device (201) may display the fourth image on the display (260) instead of the first image. For example, others (or users) located at a distance greater than or equal to the first security distance from the display 260 may not be able to easily identify the first information included in the fourth image through their eyes. Accordingly, the electronic device 201 may provide a screen protection function that prevents/blocks/obscures others located at a distance greater than or equal to the first security distance from the display 260 from easily identifying the first information.

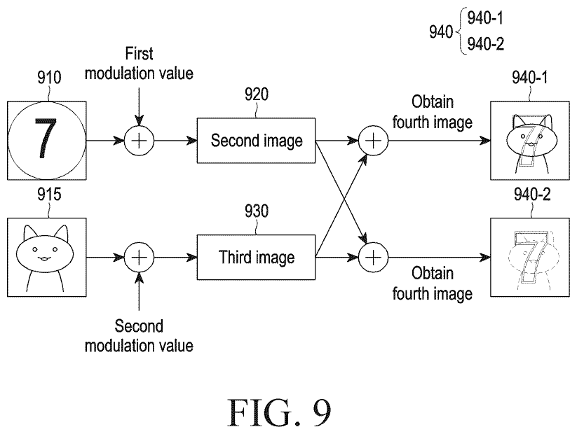

FIG. 9 is a diagram illustrating an example method in which an electronic device modifies a first image including first information into a fourth image that others may not identify, according to various embodiments.

Referring to FIG. 9, according to an embodiment, an electronic device (e.g., the electronic device 201 of FIG. 2) may display a first image 910 including first information through a display (e.g., the display 260 of FIG. 2). The electronic device 201 may identify a first security distance designated by a user input or automatically designated based on performing a function for screen security. The electronic device 201 may identify a first value based on the first security distance. The electronic device 201 may determine or identify a first modulation value of a first filter and a second modulation value of a second filter based on the first value.

According to an embodiment, the electronic device 201 may obtain a second image 920 based on filtering the first image 910 through the first filter to which the first modulation value is applied. For example, in the second image 920, at least one of an inner part or an outer part of the object may be transformed with respect to a boundary between an object representing the first information included in the first image 910 and a background excluding the object, based on the first modulation value.

According to an embodiment, the electronic device 201 may obtain a third image 930 based on filtering a designated image 915 through the second filter to which the second modulation value is applied. For example, the designated image 915 may be different from the first image 910. The designated image 915 may be pre-stored in the electronic device 201. The third image 930 may include an image to which a blur effect is applied to the designated image 915. For example, the third image 930 may include an image to which a blur effect based on the second modulation value is applied to the designated image 915.

According to an embodiment, the electronic device 201 may obtain or generate a fourth image 940 using the second image 920 and the third image 930. For example, the electronic device 201 may obtain a fourth image 940-1 in which colors are inverted with respect to an edge of an object included in the second image 920, based on subtracting the second image 920 from the third image 930. Alternatively, the electronic device 201 may obtain a fourth image 940-2 processed so that an object (letter, number, or symbol) included in the second image 920 appears thin, based on adding the second image 920 to the third image 930.

Based on the above-described method, the electronic device 201 may obtain the fourth image 940 that satisfies the first security distance.

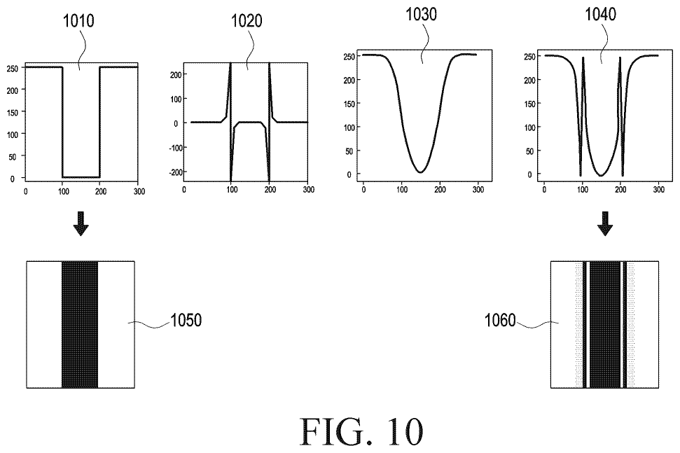

FIG. 10 is a includes graphs illustrating an example method in which an electronic device obtains a second image in which an object included in a first image is transformed, according to various embodiments.

Referring to FIG. 10, according to an embodiment, an electronic device (e.g., the electronic device 201 of FIG. 2) may identify the first modulation value of the first filter and the second modulation value of the second filter based on a first value corresponding to the first security distance.

According to an embodiment, a first graph 1010 may represent values (e.g., pixel values) corresponding to the first image. A second graph 1020 may represent values (e.g., pixel values) corresponding to the second image obtained through the first filter to which the first modulation value is applied. A third graph 1030 may represent values (e.g., pixel values) corresponding to the third image obtained through the second filter to which the second modulation value is applied. A fourth graph 1040 may represent values (e.g., pixel values) corresponding to the fourth image obtained using the second image and the third image. For example, the fourth graph 1040 may be obtained based on a combination (e.g., adding or subtracting combination) of the second graph 1020 and the third graph 1030.

According to an embodiment, a portion 1050 of the first image (e.g., a portion of an object representing the first information) may be transformed like a portion 1060 of the fourth image (e.g., a portion of an object representing the first information). For example, the portion 1050 of the first image corresponding to the first graph 1010 may have its edge portion transformed like the portion 1060 of the fourth image corresponding to the fourth graph 1040 based on the first modulation value. For example, in the portion 1050 of the first image, at least one of an inner part or an outer part of the object may be transformed with respect to a boundary between the object included in the first image and a background excluding the object, based on the first modulation value.

Based on the above-described method, the electronic device 201 may obtain the fourth image that satisfies the first security distance.

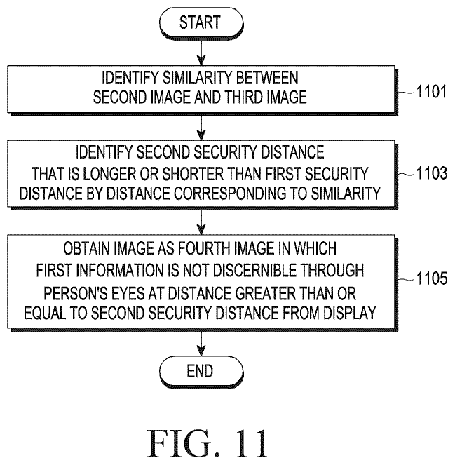

FIG. 11 is a flowchart illustrating an example method in which an electronic device obtains a fourth image considering an error in security distance, according to various embodiments. FIG. 12 is a graph illustrating an example method in which an electronic device obtains a fourth image considering an error in security distance, according to various embodiments.

Referring to FIG. 11, according to an embodiment, in obtaining the fourth image, an electronic device (e.g., the electronic device 201 of FIG. 2) may perform an operation of correcting a distance error based on similarity between the second image and the third image.

According to an embodiment, in operation 1101, the electronic device 201 may identify a similarity between the second image and the third image. For example, the electronic device 201 may identify the similarity based on whether a first attribute including at least one of a size, color, or type of an object included in the second image matches a second attribute including at least one of a color, type, or pattern of the third image.

According to an embodiment, the electronic device 201 may identify an error distance based on the similarity between the second image and the third image. For example, as the second image and the third image become more similar, a distance at which actual eyes of the person (e, g. a user and/or other people) may not identify may increase. Alternatively, as the second image and the third image become less similar, a distance at which actual person's eyes may not identify may decrease.

Referring to FIG. 12, according to an embodiment, a graph 1210 may represent values corresponding to the similarity between the second image and the third image. For example, when a value (e.g., SSIM) representing the similarity between the second image and the third image is 0.20, the error distance may be 0. When the value representing the similarity between the second image and the third image is 0.35, the error distance may be −10 (e.g., 10 cm). When the value representing the similarity between the second image and the third image is 0.10, the error distance may be 5 (e.g., 5 cm).

According to an embodiment, in operation 1103, the electronic device 201 may identify a second security distance that is longer or shorter than the first security distance designated by a user input or automatically by a distance (e.g., error distance) corresponding to the similarity. For example, if the error distance is 0, the second security distance may be the same as or similar to the first security distance. For example, if the error distance is −10, the second security distance may be 10 cm shorter than the first security distance. For example, if the error distance is 5, the second security distance may be 5 cm longer than the first security distance.

According to an embodiment, in operation 1105, the electronic device 201 may obtain an image in which the first information is not discernible through the eyes of the person (e, g. a user and/or other people) at a distance greater than or equal to the second security distance from the display (e.g., the display 260 of FIG. 2) as the fourth image. For example, the electronic device 201 may identify a first value corresponding to the second security distance. The electronic device 201 may obtain the fourth image based on the identified first value. For example, the fourth image may include an image that satisfies a security distance shorter or longer than the first security distance by the error distance. Alternatively, when the error distance is 0, the fourth image may include an image that satisfies the first security distance.

Based on the above-described method, the electronic device 201 may obtain the fourth image that corrects a distance error based on the similarity between the second image and the third image.

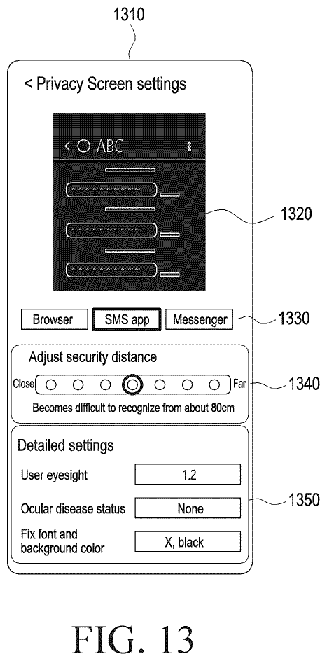

FIG. 13 is a diagram illustrating an example user interface supported by an application for screen security, according to various embodiments.

Referring to FIG. 13, according to an embodiment, an electronic device (e.g., the electronic device 201 of FIG. 2) may display a user interface 1310 (e.g., an execution screen of the application) supported by an application for a screen protection function on a display (e.g., the display 260 of FIG. 2).

According to an embodiment, the user interface 1310 may include a preview screen window 1320, a first menu 1330 for selecting an application type, a control menu 1340 for adjusting security distance, and a second menu 1350 for detailed settings.

According to an embodiment, the electronic device 201 may display a screen on which the fourth image including the first information is displayed through the preview screen window 1320.

According to an embodiment, the electronic device 201 may identify user input selecting an application (or application type) on which the fourth image is displayed for the first menu 1330. The electronic device 201 may obtain the fourth image based on the selected application (or application type). Further, the electronic device 201 may display a preview screen on which the fourth image is displayed on the execution screen of the corresponding application through the preview screen window 1320 based on the selected application (or application type). When the selected application is executed, the electronic device 201 may automatically execute the screen protection function. For example, when a screen including the first information is displayed on the execution screen of the selected application, the electronic device 201 may change the first image including the first information included in the corresponding screen to the fourth image.

According to an embodiment, the electronic device 201 may obtain information about the first security distance based on user input to the control menu 1340. For example, the electronic device 201 may obtain a security distance corresponding to the corresponding object as information about the first security distance based on identifying user input selecting an object representing a specific security distance. For example, the user input may include a tap input or a drag input to the control menu 1340. For example, the electronic device 201 may designate or set a security distance intended by the user based on user input to the control menu 1340.

According to an embodiment, the electronic device 201 may obtain additional information for generating the fourth image based on user input to the second menu 1350. For example, the electronic device 201 may obtain information about the user's eyesight, the user's ocular health (e.g., whether there is an ocular disease), and the font (e.g., object type and/or object color) and background color (or background color) of the fourth image. The electronic device 201 may generate or obtain the fourth image based on the obtained information. For example, when the first image including the first information is displayed on the display 260, the electronic device 201 may convert the first image to the fourth image considering the additional information. For example, the fourth image may be generated considering the font (e.g., object type and/or object color) and background color included in the additional information.

According to an embodiment, an electronic device 201 may include a display 260, at least one processor 220, and memory 230 storing instructions. According to an embodiment, the instructions may, when executed by the at least one processor individually or collectively, cause the electronic device to determine to display a first image including first information on the display. According to an embodiment, the instructions may, when executed by the at least one processor individually or collectively, cause the electronic device to, based on performing a function for screen security, identify a first security distance at which the first information is not discernible by person's eyes when the person views the display. According to an embodiment, the instructions may, when executed by the at least one processor individually or collectively, cause the electronic device to identify a first value for modifying the first image based on the first security distance. According to an embodiment, the instructions may, when executed by the at least one processor individually or collectively, cause the electronic device to, based on the first value, obtain a second image by converting an object representing the first information included in the first image through a first filter corresponding to a first frequency band and a third image by converting a designated image different from the first image through a second filter corresponding to a second frequency band different from the first frequency band. According to an embodiment, the instructions may, when executed by the at least one processor individually or collectively, cause the electronic device to obtain a fourth image in which the first information is not discernible by the eyes at a distance greater than or equal to the first security distance from the display, using the second image and the third image. According to an embodiment, the instructions may, when executed by the at least one processor individually or collectively, cause the electronic device to modify the first image into the fourth image.

According to an embodiment, the instructions may, when executed by the at least one processor individually or collectively, cause the electronic device to identify a first modulation value of the first filter and a second modulation value of the second filter based on the first value. According to an embodiment, the instructions may, when executed by the at least one processor individually or collectively, cause the electronic device to obtain the second image in which at least one of an inner part or an outer part of the object is transformed with respect to a boundary between the object included in the first image and a background excluding the object, based on the first modulation value. According to an embodiment, the instructions may, when executed by the at least one processor individually or collectively, cause the electronic device to obtain the third image in which the designated image is blurred based on the second modulation value.

According to an embodiment, the first value may be determined based on a first similarity between the second image and the fourth image obtained using a contrast sensitivity function (CSF) representing distance-dependent identification sensitivity and a second similarity between the third image and the fourth image.

According to an embodiment, the first similarity may be determined based on a first Euclidean distance between the distance-specific spatial frequency of the second image identified using the CSF and the distance-specific spatial frequency of the fourth image. According to an embodiment, the second similarity may be determined based on a second Euclidean distance between the distance-specific spatial frequency of the third image identified using the CSF and the distance-specific spatial frequency of the fourth image.

According to an embodiment, the first value may include a value representing a ratio between the first similarity and the second similarity.

According to an embodiment, the contrast sensitivity function may be determined based on at least one of the age, the eyesight, the ocular health information, a color of an object included in the fourth image, or a color of a background included in the fourth image.

According to an embodiment, the instructions may, when executed by the at least one processor individually or collectively, cause the electronic device to identify a similarity between the second image and the third image. According to an embodiment, the instructions may, when executed by the at least one processor individually or collectively, cause the electronic device to identify a second security distance that is longer or shorter than the first security distance by a distance corresponding to the similarity. According to an embodiment, the instructions may, when executed by the at least one processor individually or collectively, cause the electronic device to obtain an image in which the first information is not discernible through the user's eyes at a distance greater than or equal to the second security distance from the display as the fourth image.

According to an embodiment, the instructions may, when executed by the at least one processor individually or collectively, cause the electronic device to identify the similarity based on whether a first attribute including at least one of a size, color, or type of an object included in the second image matches a second attribute including at least one of a color, type, or pattern of the third image.

According to an embodiment, the instructions may, when executed by the at least one processor individually or collectively, cause the electronic device to obtain information about the first security distance based on user input to a user interface of an application for screen security.

According to an embodiment, the instructions may, when executed by the at least one processor individually or collectively, cause the electronic device to display a control menu for adjusting the first security distance through a user interface of an application for screen security.

According to an embodiment, a method of operating an electronic device 201 may include an operation of determining to display a first image including first information on a display 260 included in the electronic device. According to an embodiment, the method of operating the electronic device includes an operation of identifying a first security distance at which the first information is not discernible by person's eyes when the person views the display, based on performing a function for screen security. According to an embodiment, the method of operating the electronic device includes an operation of identifying a first value for modifying the first image based on the first security distance. According to an embodiment, the method of operating the electronic device includes an operation of obtaining a second image by converting an object representing the first information included in the first image through a first filter corresponding to a first frequency band and a third image by converting a designated image different from the first image through a second filter corresponding to a second frequency band different from the first frequency band, based on the first value. According to an embodiment, the method of operating the electronic device may include an operation of obtaining a fourth image in which the first information is not discernible by the eyes at a distance greater than or equal to the first security distance from the display, using the second image and the third image. According to an embodiment, the method of operating the electronic device includes an operation of modifying the first image into the fourth image.

According to an embodiment, the operation of obtaining the third image may include an operation of identifying a first modulation value of the first filter and a second modulation value of the second filter based on the first value. According to an embodiment, the operation of obtaining the third image may include an operation of obtaining the second image in which at least one of an inner part or an outer part of the object is transformed with respect to a boundary between the object included in the first image and a background excluding the object, based on the first modulation value. According to an embodiment, the operation of obtaining the third image may include an operation of obtaining the third image in which the designated image is blurred based on the second modulation value.

According to an embodiment, the operation of obtaining the fourth image may include an operation of identifying a similarity between the second image and the third image. According to an embodiment, the operation of obtaining the fourth image may include an operation of identifying a second security distance that is longer or shorter than the first security distance by a distance corresponding to the similarity. According to an embodiment, the operation of obtaining the fourth image may include an operation of obtaining an image in which the first information is not discernible through the user's eyes at a distance greater than or equal to the second security distance from the display as the fourth image.

According to an embodiment, the method of operating the electronic device may further include an operation of obtaining information about the first security distance based on user input to a user interface of an application for screen security.

According to an embodiment, in a non-transitory computer-readable storage medium 130, 230 storing instructions, the instructions may, when executed by at least one processor 220 individually or collectively, cause an electronic device 201 to determine to display a first image including first information on a display 260 included in the electronic device, identify a first security distance at which the first information is not discernible through person's eyes when the person views the display based on performing a function for screen security, identify a first value for modifying the first image based on the first security distance, obtain a second image by converting an object representing the first information included in the first image through a first filter corresponding to a first frequency band and a third image by converting a designated image different from the first image through a second filter corresponding to a second frequency band different from the first frequency band based on the first value, obtain a fourth image in which the first information is not discernible by the eyes at a distance greater than or equal to the first security distance from the display using the second image and the third image, and modify the first image into the fourth image.

An embodiment(s) of the disclosure and terms used therein are not intended to limit the technical features described in the disclosure to specific embodiments, and should be understood to include various modifications, equivalents, or substitutes of the embodiment. In connection to the description of the drawings, similar reference numerals may be used for similar or related components. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device). For example, a processor (e.g., the processor) of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities. Some of the plurality of entities may be separately disposed in different components. According to embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device, comprising:
a display;
at least one processor comprising processing circuitry; and
memory storing instructions, wherein at least one processor, individually and/or collectively, is configured to execute the instructions and to cause the electronic device to:
determine to display, on the display, a first image including first information;
based on performing a function for screen security, identify a first security distance at which the first information is not discernible by person's eyes when the person views the display;
identify a first value for modifying the first image based on the first security distance;
based on the first value, obtain a second image by converting an object representing the first information included in the first image through a first filter corresponding to a first frequency band and a third image by converting a designated image different from the first image through a second filter corresponding to a second frequency band different from the first frequency band;
obtain a fourth image in which the first information is not discernible by the eyes at a distance greater than or equal to the first security distance from the display, using the second image and the third image; and
modify the first image into the fourth image.

2. The electronic device of claim 1, wherein at least one processor, individually and/or collectively, is configured to cause the electronic device to:
identify a first modulation value of the first filter and a second modulation value of the second filter based on the first value;
obtain the second image in which at least one of an inner part or an outer part of the object is transformed with respect to a boundary between the object included in the first image and a background excluding the object, based on the first modulation value; and
obtain the third image in which the designated image is blurred based on the second modulation value.

3. The electronic device of claim 1, wherein the first value is determined based on a first similarity between the second image and the fourth image, and a second similarity between the third image and the fourth image, obtained using a contrast sensitivity function (CSF) representing a distance-dependent identification sensitivity.

4. The electronic device of claim 3, wherein the first similarity is determined based on a first Euclidean distance between the distance-specific spatial frequency of the second image identified using the CSF and the distance-specific spatial frequency of the fourth image, and the second similarity is determined based on a second Euclidean distance between the distance-specific spatial frequency of the third image identified using the CSF and the distance-specific spatial frequency of the fourth image.

5. The electronic device of claim 3, wherein the first value includes a value representing a ratio between the first similarity and the second similarity.

6. The electronic device of claim 3, wherein the contrast sensitivity function is determined based on at least one of an age, an eyesight, ocular health information, a color of an object included in the fourth image, or a color of a background included in the fourth image.

7. The electronic device of claim 1, wherein at least one processor, individually and/or collectively, is configured to cause the electronic device to:
identify a similarity between the second image and the third image;
identify a second security distance longer or shorter than the first security distance by a distance corresponding to the similarity; and
obtain an image, as the fourth image, in which the first information is not discernible by the eyes, at a distance greater than or equal to the second security distance from the display.

8. The electronic device of claim 7, wherein at least one processor, individually and/or collectively, is configured to cause the electronic device to:
identify the similarity based on whether a first attribute including at least one of a size, color, or type of an object included in the second image matches a second attribute including at least one of a color, type, or pattern of the third image.

9. The electronic device of claim 1, wherein at least one processor, individually and/or collectively, is configured to cause the electronic device to:
obtain information about the first security distance based on an input to a user interface of an application for screen security.

10. The electronic device of claim 1, wherein at least one processor, individually and/or collectively, is configured to cause the electronic device to:
display a control menu for adjusting the first security distance through a user interface of an application for screen security.

11. A method of operating an electronic device, the method comprising:
determining to display, on a display included in the electronic device, a first image including first information;
based on performing a function for screen security, identifying a first security distance at which the first information is not discernible by person's eyes when the person views the display;
identifying a first value for modifying the first image based on the first security distance;
based on the first value, obtaining a second image by converting an object representing the first information included in the first image through a first filter corresponding to a first frequency band and a third image by converting a designated image different from the first image through a second filter corresponding to a second frequency band different from the first frequency band;
obtaining a fourth image in which the first information is not discernible by the eyes at a distance greater than or equal to the first security distance from the display, using the second image and the third image; and
modifying the first image using the fourth image.

12. The method of claim 11, wherein obtaining the third image includes:
identifying a first modulation value of the first filter and a second modulation value of the second filter based on the first value;
obtaining the second image in which at least one of an inner part or an outer part of the object is transformed with respect to a boundary between the object included in the first image and a background excluding the object, based on the first modulation value; and
obtaining the third image in which the designated image is blurred based on the second modulation value.

13. The method of claim 11,
wherein the first value is determined based on a first similarity between the second image and the fourth image, and a second similarity between the third image and the fourth image, obtained using a contrast sensitivity function (CSF) representing a distance-dependent identification sensitivity.

14. The method of claim 13,
wherein the first similarity is determined based on a first Euclidean distance between the distance-specific spatial frequency of the second image identified using the CSF and the distance-specific spatial frequency of the fourth image, and
wherein the second similarity is determined based on a second Euclidean distance between the distance-specific spatial frequency of the third image identified using the CSF and the distance-specific spatial frequency of the fourth image.

15. The method of claim 13,
wherein the first value includes a value representing a ratio between the first similarity and the second similarity.

16. The method of claim 13,
wherein the contrast sensitivity function is determined based on at least one of age, eyesight, ocular health information, a color of an object included in the fourth image, or a color of a background included in the fourth image.

17. The method of claim 11, wherein obtaining the fourth image includes:
identifying a similarity between the second image and the third image;
identifying a second security distance longer or shorter than the first security distance by a distance corresponding to the similarity; and
obtaining an image, as the fourth image, in which the first information is not discernible by the eyes at a distance greater than or equal to the second security distance from the display.

18. The method of claim 17,
wherein the similarity is identified based on whether a first attribute including at least one of a size, color, or type of an object included in the second image matches a second attribute including at least one of a color, type, or pattern of the third image.

19. The method of claim 11, further comprising:
obtaining information about the first security distance based on an input to a user interface of an application for screen security.

20. A non-transitory computer-readable storage medium storing instructions,
wherein the instructions, when executed by at least one processor, comprising processing circuitry, of an electronic device, individually and/or collectively, cause the electronic device to:
determine to display, on a display included in the electronic device, a first image including first information;
based on performing a function for screen security, identify a first security distance at which the first information is not discernible by person's eyes when the person views the display;
identify a first value for modifying the first image based on the first security distance;
based on the first value, obtain a second image by converting an object representing the first information included in the first image through a first filter corresponding to a first frequency band and a third image by converting a designated image different from the first image through a second filter corresponding to a second frequency band different from the first frequency band;
obtain a fourth image in which the first information is not discernible by the eyes at a distance greater than or equal to the first security distance from the display, using the second image and the third image; and
modify the first image into the fourth image.
